(19) United States
(12) Patent Application Publication
(10) Pub. No.: US 2013/0343372 A1
(43) Pub. Date: Dec. 26, 2013

(54) FEMTOCELL BASE STATION SYNCHRONIZATION

(71) Applicant: Nicholas William Whinnett, Marlborough (GB)

(72) Inventor: Nicholas William Whinnett, Marlborough (GB)

(21) Appl. No.: 13/531,434

(22) Filed: Jun. 22, 2012

(51) Int. Cl. H04J 3/06; H04B 7/208

(52) U.S. Cl. 370/344

(57) ABSTRACT

There is provided a method of refining a timing estimate used to synchronize a femtocell base station to a macrocell base station. The method in the femtocell base station comprises estimating a multipath power delay profile from signals received from the macrocell base station, detecting the earliest path in the multipath power delay profile and determining a correction to the timing estimate from the earliest path detected in the multipath power delay profile.

### 1. FIELD OF THE INVENTION

The invention relates to the synchronization of a femtocell base station to a macrocell base station, and in particular to a method for reducing the effect of multipath delay spread when synchronizing a femtocell base station to a macrocell base station.

### 2. BACKGROUND TO THE INVENTION

Femtocell base stations in a Long Term Evolution (LTE) communication network (otherwise known as Home evolved Node Bs—HeNBs—or Enterprise evolved Node Bs—EeNBs) are small, low-power, indoor cellular base stations for residential or business use. They provide better network coverage and capacity than that available in such environments from the overlying macrocellular LTE network. Femtocell base stations use a broadband connection to receive data from and send data back to the operator's network (known as “backhaul”).

Base stations (whether for femtocells, picocells, macrocells, etc.) in an LTE communication network can support frequency division duplexing (FDD) and time division duplexing (TDD). TDD base stations use a carrier at a single frequency for uplink and downlink communications by partitioning the carrier in time between the uplink (UL) and downlink (DL).

In communication networks where multiple TDD base stations use a carrier at the same frequency, it is necessary to time synchronize the base stations to prevent the uplink and downlink transmissions from the base stations overlapping in time, which causes interference. This problem is illustrated in FIG. 1 for two macrocell base stations.

FIG. 1 shows first and second TDD macrocell base stations 2, 4 having respective coverage areas indicated by macrocell 6, 8. In an LTE communication network, the macrocell base stations are referred to as evolved Node Bs (eNBs).

A first user equipment (UE) 10 is located in the coverage area of the first macrocell base station 2, close to the edge of the macrocell area 6. The first UE 10 is being served by the first macrocell base station 2 (so it is referred to as a macro UE, or mUE) which means that it transmits and/or receives control signalling and/or data using the macrocell base station 2. Due to the location of the first UE 10 at the edge of the first macrocell 6, the first UE 10 receives weak downlink signals 12 from the first macrocell base station 2.

A second UE 14 is located in the coverage area of the second macrocell base station 4, but close to the edge of the macrocell area 8. The second UE 14 is being served by the second macrocell base station 4. The second UE 14 is also located close to the first UE 10.

Assuming that the first and second macrocell base stations 2, 4 are using the same frequency carrier, uplink signals 16 from the second UE 14 to the second macrocell base station 4 may cause significant interference at the nearby first UE 10 if the first and second macrocell base stations 2, 4 are not time synchronised.

A similar problem exists for a femtocell base station located within the coverage area of a macrocell base station, so time synchronization is required if a femtocell base station and macrocell base station share a carrier frequency. This synchronization can prevent interference for a macro UE receiving a downlink signal from the macrocell base station from uplink signals being transmitted by a nearby femto UE (i.e. a UE being served by the femtocell base station).

In a conventional LTE network, a femtocell base station can synchronize with a macrocell base station as follows. Firstly, the femtocell base station detects a Primary Synchronisation Sequence transmitted by the macrocell base station, which allows the femtocell base station to obtain the orthogonal frequency-division multiplexing (OFDM) symbol timing of the macrocell base station and a frequency offset between the femtocell base station and macrocell base station.

Next, the femtocell base station detects a Secondary Synchronisation Sequence transmitted by the macrocell base station, from which the femtocell base station determines the frame timing (i.e. the timing of the 10 ms frames) of the transmissions from the macrocell base station.

The femtocell base station can then refine the frequency offset measurement by measuring downlink reference symbols transmitted by the macrocell base station.

The frequency of a clock maintained in the femtocell base station is then adjusted based on the refined frequency offset and the symbol and frame timing of transmissions from the femtocell base station are adjusted to align with the transmissions by the macrocell base station.

This process can be periodically repeated by the femtocell base station.

3GPP RAN4 have agreed a specification on TDD femtocell timing accuracy for LTE (TS 36.133 v10.1.0 section 7.4.2). The specification indicates that the timing of transmissions in a femtocell should be synchronized with those in an overlying macrocell to within 3 μs.

If the femtocell base station obtains its synchronization by locking on to (or “sniffing”) synchronization information transmitted by a macrocell base station in a downlink as described above then the 3 μs accuracy requirement holds for up to 500 m separation between the femtocell base station and the macrocell base station.

The one-way propagation delay between the macrocell base station and the femtocell base station with a separation of 500 m is approximately 1.6 μs. As well as this propagation delay, the signal from the macrocell base station is subject to scattering due to reflection off objects (buildings, etc.) such that multiple delayed versions (or echoes) of the signal from the macrocell base station will be received at the femtocell base station. This is known as multipath propagation and results in a multipath “delay spread” (which is the time between the earliest received version and the last detectable echo of the signal). This multipath delay spread can be of the order of 0.5 μs and leads to timing uncertainty.

Thus, in a typical femtocell base station/macrocell base station arrangement, the propagation delay plus delay spread uncertainty could be of the order of 2 μs, which means that the hardware in femtocell base station has to be accurate to approximately 1 μs to meet the 3 μs accuracy requirement. Building hardware with this accuracy requires significant effort and complexity to achieve.

Therefore, there is a need for a way to reduce the effect of multipath delay spread when synchronizing a femtocell base station to a macrocell base station.

### SUMMARY OF THE INVENTION

According to a first aspect of the invention, there is provided a method of refining a timing estimate used to synchronize a femtocell base station to a macrocell base station, the method in the femtocell base station comprising estimating a multipath power delay profile from signals received from the macrocell base station; detecting the earliest path in the multipath power delay profile; and determining a correction to the timing estimate from the earliest path detected in the multipath power delay profile.

According to a second aspect of the invention, there is provided a method of synchronizing a femtocell base station to a macrocell base station, the method comprising determining an initial timing estimate for synchronizing the femtocell base station to the macrocell base station from signals received from the macrocell base station; and refining the initial timing estimate using the correction determined according to the method described above.

According to a third aspect of the invention, there is provided a computer program product comprising computer-readable code embodied therein, the computer-readable code being configured to cause a computer or processor to perform the method described above.

According to a fourth aspect of the invention, there is provided a femtocell base station for use in a communication network comprising at least one macrocell base station, the femtocell base station comprising a processor configured to refine a timing estimate used to synchronize a femtocell base station to a macrocell base station by estimating a multipath power delay profile from signals received from the macrocell base station; detecting the earliest path in the multipath power delay profile; and determining a correction to the timing estimate from the earliest path detected in the multipath power delay profile.

### BRIEF DESCRIPTION OF THE DRAWINGS

Embodiments of the invention will now be described in detail, by way of example only, with reference to the following drawings, in which:

FIG. 1 shows a macrocellular communication network;

FIG. 2 shows an exemplary communication network including a femtocell base station in which the invention can be implemented;

FIG. 3 is a block diagram of a femtocell base station in accordance with the invention;

FIG. 4 is a flow chart illustrating a method of determining a timing estimate according to the invention for use in synchronizing a femtocell base station to a macrocell base station;

FIG. 5 is an exemplary multipath power delay profile determined according to the invention; and

FIG. 6 is a flow chart illustrating an exemplary process for performing step 103 of FIG. 4.

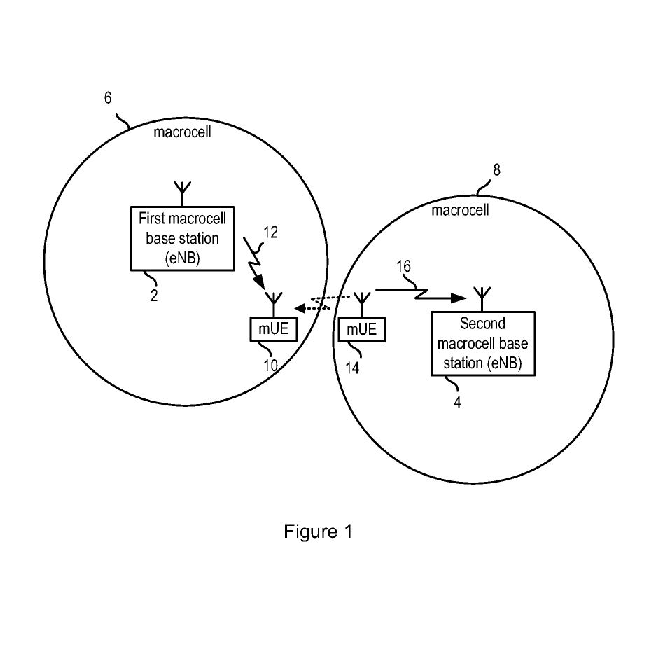

### DETAILED DESCRIPTION OF THE PREFERRED EMBODIMENTS

Although the invention will be described below with reference to an LTE communication network and femtocell base stations or HeNBs, it will be appreciated that the invention is applicable to any type of second, third or subsequent generation network in which femtocell base stations (whether for home, business or public use), or their equivalents in those networks, can be deployed, such as TD-SCDMA, WiMAX and WCDMA/HSPA, and where the femtocell base station is required to time synchronize with a macrocell base station. Moreover, although in the embodiments below the femtocell base stations and macrocell base stations use the same air interface (LTE), it will be appreciated that the invention can be used in a situation in which the macrocell and femtocell base stations use different air interface schemes (for example the macrocell base stations could use TD-SCDMA or WCDMA while the femtocell base stations use LTE).

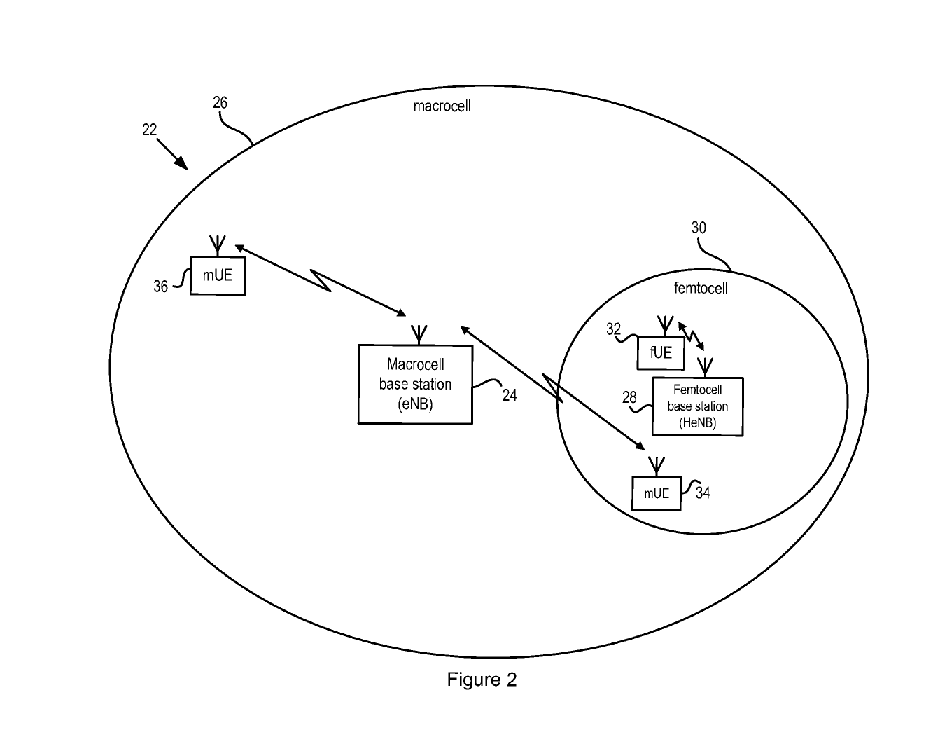

FIG. 2 shows part of an exemplary communication network 22 in which the invention can be implemented. The communication network 22 includes a plurality of macrocell base stations 24 (only one of which is shown in FIG. 2) that each define a respective coverage area indicated by macrocell 26. As indicated above, in an LTE communication network, the macrocell base stations 24 are referred to as evolved Node Bs (eNBs).

One or more femtocell base stations 28 (Home eNBs—HeNBs) can be located within the coverage area 26 of the macrocell base station 24 (although only one femtocell base station 28 is shown in FIG. 2), with each femtocell base station 28 defining a respective coverage area indicated by femtocell 30.

It will be appreciated that FIG. 2 has not been drawn to scale, and that in most real-world implementations the coverage area 30 of the femtocell base station 28 will be significantly smaller than the coverage area 26 of the macrocell base station 24.

A number of mobile devices (user equipments—UEs) 32, 34 and 36 are also located in the communication network 22 within the coverage area 26 of the macrocell base station 24.

Mobile device 32 is located within the coverage area 30 of the femtocell base station 28 and is currently being served by the femtocell base station 28, meaning that it transmits and/or receives control signaling and/or data using the femtocell base station 28. Mobile devices served by femtocell base stations are referred to as femto UEs herein.

Mobile devices 34 and 36 are each currently being served by the macrocell base station 24 (i.e. they are macro UEs), meaning that they transmit and/or receive control signaling and/or data using the macrocell base station 24. In the figure, mobile device 34 is shown as being within the coverage area 30 of the femtocell base station 28, and is therefore quite close to femto UE 32 (since the femtocell 30 covers a relatively small area), although it will be appreciated that mobile device 34 could be located outside the coverage area 30 of the femtocell base station 28 but still quite close to femto UE 32.

When the macrocell base station 24 and femtocell base station 28 use the same or a common frequency carrier it is necessary to synchronize the femtocell base station 28 with the macrocell base station 24 to avoid interference to downlink transmissions to macro UE 34 by uplink transmissions from the femto UE 32, or to downlink transmissions to the femto UE 32 by uplink transmissions from the macro UE 34.

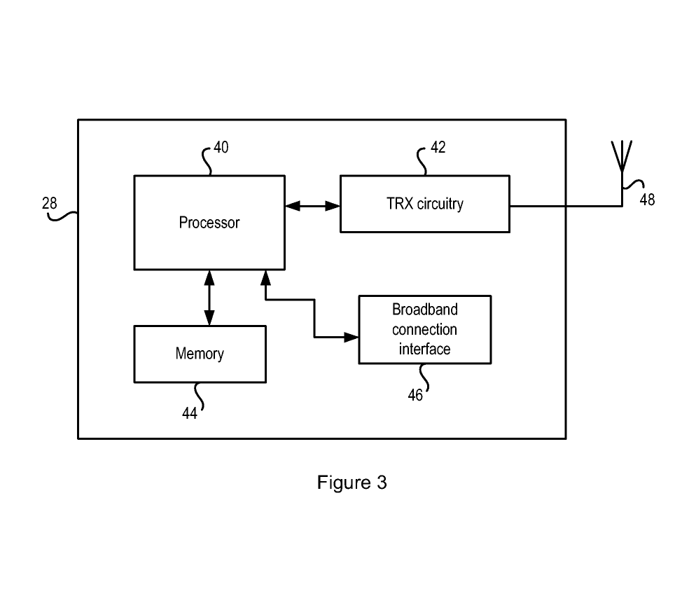

The femtocell base station 28 is illustrated in more detail in FIG. 3. The femtocell base station 28 comprises a processor 40 that controls the operation of the femtocell base station 28, transceiver circuitry 42, memory 44 and broadband connection interface 46 that are each connected to the processor 40, and an antenna 48 connected to the transceiver circuitry 42.

One function of the processor 40 is to maintain a clock or timer that is used, for example, to determine the appropriate times for transmitting and receiving signals over the air interface. During synchronization with a nearby macrocell base station 24, a timing value and frequency offset is determined that is applied to the clock of the femtocell base station 24 in order for the femtocell base station 28 to be time and frequency synchronized with the macrocell base station 24.

As described above, although the existing time synchronization method allows the femtocell base station 28 to determine a timing value from synchronization information contained in signals from the macrocell base station 24, there may be uncertainty in the determined value due to multipath delay spread. Specifically, the signal from the macrocell base station 24 observed by the femtocell base station 28 is subject to scattering due to reflection off objects (buildings, etc.) such that multiple delayed versions (or echoes) of the signal from the macrocell base station 24 will be received at the femtocell base station 28.

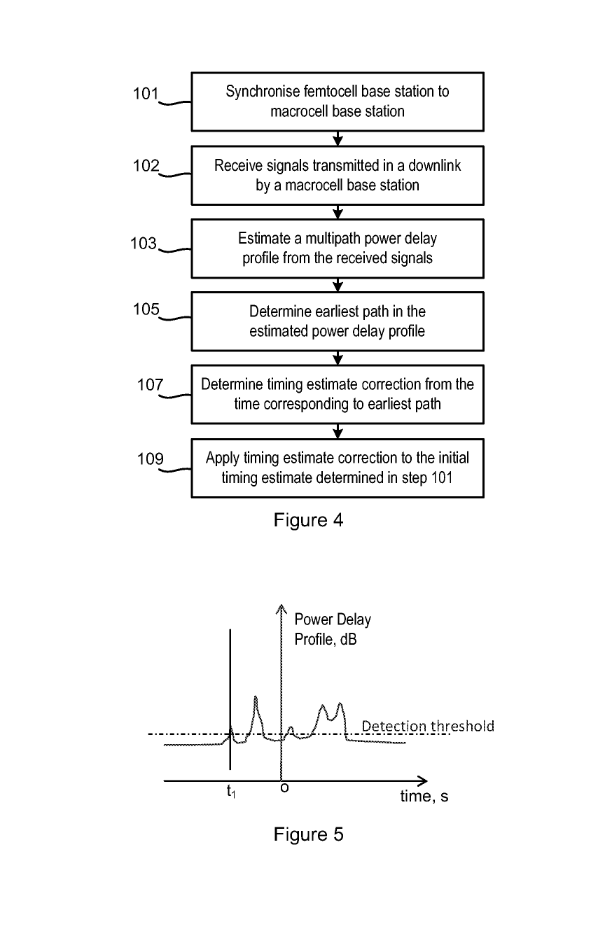

Thus, the invention provides a method for refining the timing estimate used to synchronize the femtocell base station 28 with the macrocell base station 24 to reduce the effect of multipath delay spread, thereby relaxing the constraints on the timing accuracy of the hardware in the femtocell base station 28. An exemplary process for obtaining and then refining the timing estimate is shown in FIG. 4.

Firstly (step 101), the femtocell base station 28 obtains an initial timing estimate for synchronizing with the macrocell base station 24. The femtocell base station 28 can determine a frequency offset and symbol and frame timing for transmissions from the femtocell base station in a conventional manner (for example as described in the Background section above or using any other known technique) using signals transmitted by the macrocell base station 24. The frequency of the clock maintained in the femtocell base station 28 is then adjusted based on the frequency offset and the symbol and frame timing of transmissions from the femtocell base station 28 is adjusted to align with the transmissions by the macrocell base station 24. The symbol and frame timing obtaining during this step is referred to herein as the initial timing estimate.

In a next step, step 102, the femtocell base station 28 receives signals transmitted by the macrocell base station 24. Preferably, these downlink signals from the macrocell base station 24 include reference symbols. Where the macrocell base station 24 includes multiple transmitting antennas, each antenna transmits its own set of reference symbols.

Next, the femtocell base station 28 estimates a multipath power delay profile (PDP) from the received signals (step 103). As known, a multipath power delay profile indicates the power of a signal received over a multipath channel as a function of time. An exemplary multipath power delay profile is shown in FIG. 5. It can be seen that there are a number of peaks spaced along the time axis in the profile, and it is likely that each peak corresponds to a respective path taken by the signal from the macrocell base station 24.

In order to reduce or negate the effects of changes in the multipath channel over time (for example where reflections briefly occur from vehicles or other moving objects), as well as reducing the impact of noise on the estimate, the femtocell base station 28 preferably estimates a number of multipath power delay profiles over a period of time and takes an average to generate a time-averaged multipath power delay profile. In particular embodiments, the femtocell base station 28 can estimate multipath power delay profiles every 100 ms, for example, and then average all multipath power delay profiles estimated over a 10 second window.

Alternatively, where the macrocell base station 24 includes a plurality of transmit antennas, the femtocell base station 28 can estimate a multipath power delay profile for each of the transmit antennas and average the estimated profiles.

Furthermore, it will be appreciated that the femtocell base station 28 can average estimated power delay profiles over both the number of transmit antennas and time.

Once the femtocell base station 28 has obtained the multipath power delay profile or time- and/or antenna-averaged multipath power delay profile, the femtocell base station 28 identifies the earliest path in the multipath power delay profile (step 105).

In one embodiment, a threshold can be applied to the multipath power delay profile with the earliest path being identified by the earliest point in the profile where the power exceeds the threshold. The threshold is applied in order to distinguish between signals received from the macrocell base station 24 and background noise and/or interference. The application of the threshold is illustrated in FIG. 5. Preferably the threshold has a value that is a predetermined amount above a noise and interference level, for example, 2 to 5 dB above this level. The femtocell base station 28 can estimate the noise and interference level by, for example, averaging the values at the end of the power delay profile where no paths are expected to exist.

In step 107, the femtocell base station 28 determines the timing estimate correction for use in refining or correcting the synchronization with the macrocell base station 24 as the time t₁ associated with the earliest point identified in step 105. t₁ is measured with respect to the symbol or frame timing that was obtained by the femtocell base station 28 in step 101, which is represented by the y-axis (t=0) in FIG. 5. Typically, step 101 will result in synchronization with a timing corresponding to a signal arriving somewhere within the multipath delay spread (e.g. towards the center of the delay spread if the power of all paths or echoes are equal), so t₁ provides a correction for the multipath delay spread that is applied to the initial synchronization timing estimate from step 101.

In step 109, the timing estimate correction t₁ is applied to the initial timing estimate from step 101 to improve the synchronization of the femtocell base station 28 with the macrocell base station 24. In particular, the timing estimate t₁ is used to further adjust the clock or timer operated by the processor 40 so that transmissions and receptions by the femtocell base station 28 are better synchronized with those of the macrocell base station 24 (within the required 3 μs accuracy).

Thus, using the method shown in FIG. 4, the femtocell base station 28 can determine an improved or refined timing estimate for synchronizing with the macrocell base station 24, even where there is a significant delay spread in the signals received from the macrocell base station 24.

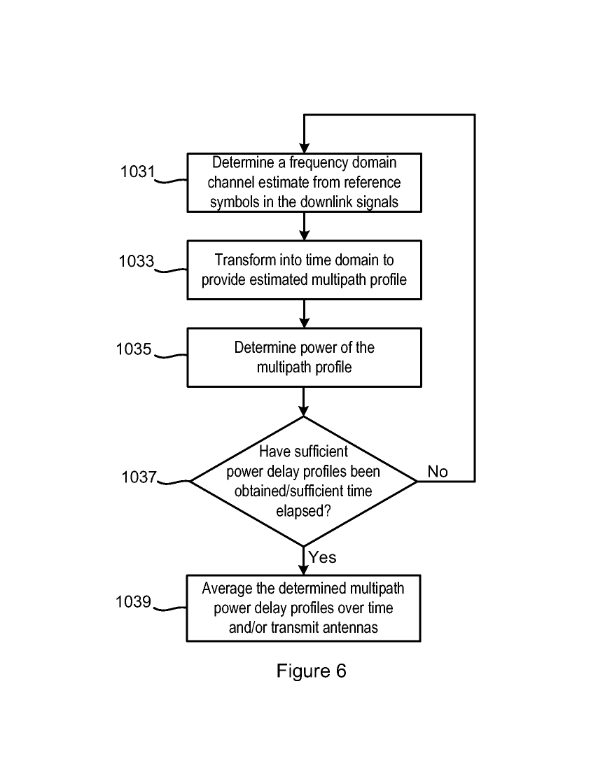

FIG. 6 shows a method for performing step 103 of FIG. 4 according to a specific embodiment of the invention in an LTE communication network (although it will be appreciated that it can also be applied to other OFDM systems, such as WiMAX and digital broadcast). Furthermore, it will be appreciated that the method described below could also be adapted for use in CDMA systems, e.g. WCDMA (by obtaining a power delay profile from the channel estimate of the common pilot channel (CPICH)) or TD-SCDMA.

In step 1031, the femtocell base station 28 determines the frequency domain channel estimate (in terms of gain and phase versus frequency) for the downlink from the macrocell base station 24 to the femtocell base station 28 from the reference symbols in the downlink signals received from the macrocell base station 24 in step 101.

In particular, in LTE the femtocell base station 28 can determine the frequency domain channel estimate for the first one of the 14 orthogonal frequency division multiplexing (OFDM) symbols in a 1 ms subframe. For the first OFDM symbol, every 6^{th} subcarrier in the frequency domain carries a reference symbol (for a given transmit antenna). The (complex) frequency domain channel estimate for each of these reference symbol positions is obtained by multiplying the received complex value with the complex conjugate of the known reference symbol transmission value for this position. Since the received reference symbols do not occupy all of the positions (subcarriers) in the frequency domain, interpolation can be performed to determine the frequency domain channel estimate for the remainder of the frequency positions (subcarriers). Interpolation could be simple linear interpolation between the reference symbols, or could make use of a more sophisticated interpolation filter approach, as known in the art.

Once the frequency domain channel estimate has been determined, the channel estimate is transformed into the time domain to obtain a multipath profile given in terms of gain and phase versus time (step 1033) which can be represented by a complex value. Preferably the transformation is an inverse Fast Fourier Transform (iFFT), although those skilled in the art will appreciate that other transformations can be applied.

In step 1035 the power of the multipath profile is obtained by taking the squared absolute value of each complex value of the multipath profile (which is equivalent to summing the squares of the real and imaginary components).

As a time-averaged multipath power delay profile is required in a preferred embodiment in order to counteract the effect of changes in the multipath channel and to smooth the noise, steps 1031, 1033 and 1035 are repeated until a sufficient time period has elapsed or a sufficient number of multipath power delay profiles have been estimated. As indicated above, in one embodiment a multipath power delay profile can be estimated every 100 ms, and the average of the profiles obtained over 10 s can be taken.

Thus, steps 1031-1035 are repeated if it is determined in decision block 1037 that a sufficient number of multipath power delay profiles have not yet been obtained (or a sufficient time has not yet elapsed).

If a sufficient number of multipath power delay profiles have been obtained (or a sufficient time has elapsed), the method can pass to step 1039 in which the obtained multipath power delay profiles are averaged over time to give the time-averaged multipath power delay profile. Alternatively, the averaging can be performed by summing the profiles as they are obtained and step 1039 could comprise simply dividing by the number of profiles. Other means of averaging, for example by filtering techniques, are known in the art. This profile is then used in steps 105 and 107 as described above to determine the refined timing estimate for synchronizing the femtocell base station 28 to the macrocell base station 24.

As described above, alternatively or in addition to averaging the obtained power delay profiles over time, the femtocell base station 28 can obtain power delay profiles for respective transmit antennas in the macrocell base station 24 and average the obtained profiles over the number of antennas.

There is therefore provided an improved method of synchronizing a femtocell base station to a macrocell base station that reduces the effect of multipath delay spread compared to conventional solutions, and a femtocell base station configured to perform the same.

It will be appreciated that, in the methods described above, where a step is described as being performed by the femtocell base station 28, the step would typically be performed by one or more of the components of the femtocell base station 28, such as the processor 40 and/or transceiver circuitry 42. Furthermore, where the invention is implemented as a series of computer readable instructions forming a computer program, the computer program can be stored in the memory 44 of the femtocell base station 28 and executed by the processor 40.

Finally, although the description above relates to the synchronization of TDD femtocell base stations to macrocell base stations, it will be appreciated that the method can also be used to synchronize FDD femtocell or picocell base stations to macrocell base stations, for example in the case of multicast transmissions, and references to a femtocell base station in the claims should be construed accordingly.

While the invention has been illustrated and described in detail in the drawings and foregoing description, such illustration and description are to be considered illustrative or exemplary and not restrictive; the invention is not limited to the disclosed embodiments.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

What is claimed is:

1. A method of refining a timing estimate used to synchronize a femtocell base station to a macrocell base station, the method in the femtocell base station comprising:
estimating a multipath power delay profile from signals received from the macrocell base station;
detecting the earliest path in the multipath power delay profile; and
determining a correction to the timing estimate from the earliest path detected in the multipath power delay profile.

2. A method as claimed in claim 1, wherein the step of detecting the earliest path in the multipath power delay profile comprises identifying the earliest part of the multipath power delay profile that exceeds a threshold value.

3. A method as claimed in claim 2, wherein the correction to the timing estimate is determined as the time corresponding to the earliest part of the multipath power delay profile that exceeds the threshold value.

4. A method as claimed in claim 2, wherein the threshold value is set a predetermined amount above the power level of noise and/or interference in the multipath power delay profile.

5. A method as claimed in claim 1, wherein estimating a multipath power delay profile comprises estimating a plurality of multipath power delay profiles and averaging the plurality of multipath power delay profiles over time or the number of estimated multipath power delay profiles to give an averaged or filtered multipath power delay profile; and
detecting the earliest path in the multipath power delay profile comprises detecting the earliest path in the averaged multipath power delay profile.

6. A method as claimed in claim 1, wherein the step of estimating a multipath power delay profile comprises estimating a multipath power delay profile for each of a plurality of transmit antennas in the macrocell base station and averaging the estimated multipath power delay profiles to give an averaged or filtered multipath power delay profile; and
detecting the earliest path in the multipath power delay profile comprises detecting the earliest path in the averaged multipath power delay profile.

7. A method as claimed in any claim 1, wherein estimating a multipath power delay profile comprises:
determining a frequency domain channel estimate for the channel between the macrocell base station and the femtocell base station from the signals received from the macrocell base station;
transforming the frequency domain channel estimate to the time domain to give an estimate of the multipath profile; and
determining the multipath power delay profile by obtaining the power of the estimated multipath profile.

8. A method as claimed in claim 7, wherein, for a first OFDM symbol, every 6^{th} subcarrier in the frequency domain carries a known reference symbol, and determining a frequency domain channel estimate comprises:
determining a frequency domain channel estimate for each reference symbol by multiplying the received complex value of the reference symbol by the complex conjugate of the known reference symbol; and
interpolating the determined frequency domain channel estimates to determine a frequency domain channel estimate for all subcarriers.

9. A method of synchronizing a femtocell base station to a macrocell base station, the method comprising:
determining an initial timing estimate for synchronizing the femtocell base station to the macrocell base station from signals received from the macrocell base station; and
refining the initial timing estimate using the correction determined according to the method of any preceding claim.

10. A femtocell base station for use in a communication network that includes at least one macrocell base station, the femtocell base station comprising:
a processor configured to execute computer-readable code;
a memory, accessible by the processor, the memory storing non-transitory computer-readable code configured to:
estimating a multipath power delay profile from signals received from the macrocell base station;
detecting the earliest path in the multipath power delay profile; and
determining a correction to the timing estimate from the earliest path detected in the multipath power delay profile.

11. A femtocell base station for use in a communication network comprising at least one macrocell base station, the femtocell base station comprising:
a processor configured to refine a timing estimate used to synchronize a femtocell base station to a macrocell base station by:
estimating a multipath power delay profile from signals received from the macrocell base station;
detecting the earliest path in the multipath power delay profile; and
determining a correction to the timing estimate from the earliest path detected in the multipath power delay profile.

12. A femtocell base station as claimed in claim 11, wherein the processor is configured to detect the earliest path in the multipath power delay profile by identifying the earliest part of the multipath power delay profile that exceeds a threshold value.

13. A femtocell base station as claimed in claim 12, wherein the processor is configured to determine the correction to the timing estimate as the time corresponding to the earliest part of the multipath power delay profile that exceeds the threshold value.

14. A femtocell base station as claimed in claim 12, wherein the processor is configured to set the threshold value a predetermined amount above the power level of noise and/or interference in the multipath power delay profile.

15. A femtocell base station as claimed in claim 11, wherein the processor is configured to estimate a multipath power delay profile by estimating a plurality of multipath power delay profiles and averaging the plurality of multipath power delay profiles over time or the number of estimated multipath power delay profiles to give an averaged or filtered multipath power delay profile, and wherein the processor is configured to detect the earliest path in the multipath power delay profile by detecting the earliest path in the averaged multipath power delay profile.

16. A femtocell base station as claimed in claim 11, wherein the processor is configured to estimate a multipath power delay profile by estimating a multipath power delay profile for each of a plurality of transmit antennas in the macrocell base station and averaging the estimated multipath power delay profiles to give an averaged or filtered multipath power delay profile, and wherein the processor is configured to detect the earliest path in the multipath power delay profile by detecting the earliest path in the averaged multipath power delay profile.

17. A femtocell base station as claimed in claim 11, wherein the processor is configured to estimate a multipath power delay profile by:
determining a frequency domain channel estimate for the channel between the macrocell base station and the femtocell base station from the signals received from the macrocell base station;
transforming the frequency domain channel estimate to the time domain to give an estimate of the multipath profile; and
determining the multipath power delay profile by obtaining the power of the estimated multipath profile.

18. A femtocell base station as claimed in claim 17, wherein, for a first OFDM symbol, every 6^{th} subcarrier in the frequency domain carries a known reference symbol, and wherein the processor is configured to determine a frequency domain channel estimate by:
determining a frequency domain channel estimate for each reference symbol by multiplying the received complex value of the reference symbol by the complex conjugate of the known reference symbol; and
interpolating the determined frequency domain channel estimates to determine a frequency domain channel estimate for all subcarriers.

19. A femtocell base station as claimed in claim 11, wherein the processor is further configured to:
determine an initial timing estimate for synchronizing the femtocell base station to the macrocell base station from signals received from the macrocell base station; and
refine the initial timing estimate using the determined correction to the timing estimate.
